(19) United States
(12) Patent Application Publication
(10) Pub. No.: US 2005/0246763 A1
(43) Pub. Date: Nov. 3, 2005

(54) Secure digital content reproduction using biometrically derived hybrid encryption techniques

(75) Inventors: Peter Corcoran, Claregalway (IE); Alex Cucos, Cluain Ard (IE)

Correspondence Address: DLA PIPER RUDNICK GRAY CARY US LLP, 153 TOWNSEND STREET, SUITE 800, SAN FRANCISCO, CA, 94107-1907, US

(73) Assignee: National University of Ireland, Galway (IE)

(21) Appl. No.: 11/090,974

(22) Filed: Mar. 24, 2005

(30) Foreign Application Priority Data
Mar. 25, 2004 (IE) S2004/0189

(51) Int. Cl. H04L 9/00

(52) U.S. Cl. 726/3

(57) ABSTRACT

A secure digital content reproduction method includes generating a private-public cryptographic key pair from a biometric signature. The public key is provided to one or more sources of digital content. A CE appliance receives the digital content secured with the public key. By applying the corresponding private key, rendering of the secured digital content is permitted.

### BACKGROUND

1. Field of the Invention

The invention relates to the field of consumer electronics, particularly to the field of networked consumer appliances which can produce and consumer digital audio/video data. The invention also relates to the field of digital audio/video content protection, particularly the field of content protection using public key techniques. The invention also relates to the field of biometric authentication, particularly the use of biometric authentication to sign and encrypt digital content.

2. Description of the Related Art

It is desired to be able to adequately secure digital content that is communicated between various consumer electronic devices. It is recognized by the inventors of the present invention that it would be advantageous to use public key technology with biometric identification for the purposes of signing and/or securing digital content.

### The Changing Home Audionideo Appliance Infrastructure

Traditionally our homes have been filled with stand-alone Consumer Electronic (CE) appliances such as the TV set or single add-on appliances such as the VCR or DVD player which allow us to record our favorite TV shows and play pre-recorded movies. However in the last couple of years we have seen the emergence of a new generation of digital CE appliances such as PVRs (personal video recorders such as TiVo, Sky+, etc) and in the past 12 months Media Adapters. (A Media Adapter is an appliance which can receive streamed digital video or music over a network connection and convert it to standard RCA or S-Video output for presentation on a standard TV set).

A further major catalyst is the emergence of 802.11 WLAN technology as a means of wireless home networking. The cost of 802.11g access points is rapidly falling which will further drive the market for networked CE products as consumers begin to perceive the benefits and simplicity of these new wireless networking technologies.

FIG. 1 illustrates an exemplary home networking environment [101] that next-generation CE appliances [102, 104] may “live” in. A local network of CE appliances is shown interoperating over wired islands [103] which are glued together by bridging routers [109] to a home wireless 802.1 μg network [105]. This local network is connected, in turn, via a gateway appliance [108] to an external wide area network (WAN) [106], effectively the broadband connection to the home. As is recognized by the inventors of the present invention, in addition to local network appliances, a remote Internet server [107] may be employed to store and provide general access to public keys required for encoding and decoding of digital multimedia content.

### Copyright Issues and Peer-to-Peer Networks

Since the emergence of peer-to-peer networking, there has been significant media focus on the issue of illegal versus “fair use” copying of digital content, specifically CD music and, more recently, DVD videos. The copying of digital content has created problems for both the music industry and Hollywood in recent years, particularly as there is no degradation of digital content over multiple copies. It is clear that recording and movie studios and the artists, musicians and actors who work in the music and film industry require revenue in order to exist. Thus, as a society, it is desired to have a means to manage and account for the copying and redistribution of digital multimedia.

There is a contending desire that consumers retain certain “fair use” rights to copy recordings that they have obtained legally for personal use and archival purposes. Furthermore, despite the assertions of the music industry there is strong evidence that allowing controlled copying and sharing of digital content can lead to market growth and improved sales.

Thus the challenge for content providers in today's digital age is to offer mechanisms which allow home copying combined with limited sharing of digital content to friends and family members, but which restrict commercial piracy.

For consumers, a series of recent legal actions in the context of digital copying and sharing of music in MP3 format has introduced a new uncertainty: how can a consumer prove that they are not abusing their fair use rights to copy music? The inventors of the present invention recognize that ideally consumers should be able to digitally sign copies of music to authenticate the copy as a fair use copy. In addition, consumers should also be able to secure copies of digital content in a manner that such content can only be used by a very limited number of specific users, such as family members or close friends. In this way consumers could pro-actively demonstrate compliance with recent legislation such as the DMCA.

### Conventional Cryptography

In conventional cryptography, also called secret-key or symmetric-key encryption, one key is used both for encryption and decryption. Conventional encryption has benefits. It is very fast. It is especially useful for encrypting data that is not going anywhere. However, conventional encryption alone as a means for transmitting secure data can be quite expensive simply due to the difficulty of secure key distribution.

For a sender and recipient to communicate securely using conventional encryption, they must agree upon a key and keep it secret between themselves. If they are in different physical locations, they must trust a courier, or some other secure communication medium to prevent the disclosure of the secret key during transmission.

### Public Key Cryptography

The problems of key distribution are addressed by public key cryptography, which is an asymmetric scheme that uses a pair of keys for encryption: a public key, which encrypts data, and a corresponding private key for decryption. The public key is made generally available by placing it, for example, on a website, while keeping your private key secret. Anyone with a copy of a public key of a user can then encrypt information that only the user can decrypt and read.

It is computationally infeasible to deduce the private key from the public key. Anyone who has a public key can encrypt information but cannot decrypt it. Only the person who has the corresponding private key can decrypt the information. The primary benefit of public key cryptography is that it allows people who have no preexisting security arrangement to exchange messages securely.

A further benefit of public key cryptography is that it provides a method for employing digital signatures. Digital signatures enable the recipient of information to verify the authenticity of the information's origin, and also verify that the information is intact. Thus, public key digital signatures provide authentication and data integrity. A digital signature also provides non-repudiation, which means that it prevents the sender from claiming that he or she did not actually send the information.

### BRIEF DESCRIPTION OF THE DRAWINGS

FIG. 1 illustrates an emerging home network infrastructure for consumer electronic (CE) appliances. A local wireless cell supports standard TCP/IP networking.

FIG. 2 illustrates a biometrically audited public-key technology infrastructure for secure multimedia (BAPTISM) in accordance with a preferred embodiment.

FIG. 3 illustrates an embodiment of BAPTISM which supports content provider services to uniquely authenticated end users.

FIG. 4 illustrates a mechanism for secured private key exchange over a home network.

FIG. 5 illustrates an embodiment of BAPTISM which supports secured data rebroadcast between CE appliances on a wireless home network segment.

### DETAILED DESCRIPTION OF THE PREFERRED EMBODIMENTS

Preferred embodiments are provided below that address issues raised by the emergence of next generation home networks and related consumer appliances, and the attending copyright issues surrounding digital content. The preferred embodiments offer improved means of both copy protection of digital content and digital authentication of content users. More specifically, the preferred embodiment provide:
(i) improved means to allow consumers to reliably and uniquely authenticate digital content that they have copied at home for family or personal non-profit use;
(ii) improved means to secure said content so that it can only be accessed by a limited group of end-users who can be individually and uniquely authenticated; and
(iii) improved means for content providers to prepare digital content which can only be used by a uniquely authenticated end user (or group of such end users).

The preferred embodiments offer a public key infrastructure to address issues posed by growth in digital content and consumer “fair use” rights, while at the same time restricting illegal piracy of digital media. Certain recent advances in biometric scanning technologies, specifically in fingerprint scanning and/or voice recognition, may be preferably used. In one embodiment, improved means are provided for user authentication for public key technology through the generation of key-pairs from a unique biometric signature.

In a preferred embodiment, two principle components include (i) a software/firmware client-side engine which may be incorporated within a consumer electronic appliance, and (ii) a server-side engine which implements and supports the public-key storage and management functions. Client-side aspects may include:
(a) a biometric data analysis subsystem capable of generating a unique and repeatable digital signature which can be associated with an end-user of the system; (b) a public/private key-pair generator which can create unique key-pairs based on the aforementioned digital signature;
(c) permanent storage for private keys;
(d) a recording and/or rebroadcast subsystem which encodes digital content using at least one public key, and may also digitally sign the content using an end-user's private key;
(e) a playback subsystem which can decode digital content secured with an end-user's public key; and/or
(f) a network subsystem or other data input/output subsystem which allows public key data to be imported and exported.

In one embodiment, there is no centralized key infrastructure, and thus it is more difficult to reverse-engineer private keys in order to break underlying security mechanisms. In accordance with this embodiment, each CE appliance has its own unique private key so that there is a very large number of private keys that would have to be reverse-engineered to destroy the security.

In another embodiment, it is not possible to bit-copy key secured data. Many DVD pirates simply bit-copy original media using specialized equipment. Once they have a valid bit copy, it is trivial to mass-produce pirate copies of a new DVD. With key-secured data in accordance with this embodiment, each consumer gets a unique, personalized copy of the digital multimedia content such that bit-copying is no longer practical.

In another embodiment, a system allows consumers to make restricted copies of digital multimedia for their friends and family. In order to do this, the consumer locates the public keys of the person(s) they wish to make a media copy for and the recording engine will sign the media with their private key and encode the data with the public key of the recipient. The fact that the media is permanently and irrevocably signed with the private key acts as a disincentive to abuse the recording facility and the fact that the media copy can only be used by a single recipient further restricts its value in the black market.

A system that provides one or more of these features offers an original and unique approach to the problem of copyright protection and content management in the digital age. It facilitates returning much of the responsibility for legal use of digital content back into the hands of the end user, while at the same time empowering the end user with means to authenticate their legally owned content and to copy it in a restricted manner for the sole use of friends and family. This will also provide consumers with an affirmative defense against potential legal actions arising from claims of abuse of their “fair use” rights.

In addition, because the system adds value in these ways for consumers it offers advantages over more centralized content protection systems such as the CSS system used to secure digital content on DVDs. As with any such system, there may be individuals who seek to abuse the system, but it is significantly more difficult to “crack” the system of the preferred embodiment, because that involves breaking into the secured data of individual users rather than, e.g., the secured data of a large corporate entity.

A system in accordance with another embodiment may be utilized to address issues of content protection by returning responsibility to the consumer. The system allows users to make legal copies of digital content when they digitally sign each copy they make using a unique private key which is biometrically secured to their person and/or each copy is uniquely coded to a limited number of users who provide their public keys to be available to a content copier, such that access to the content is only made possible by biometrically activating the corresponding private keys.

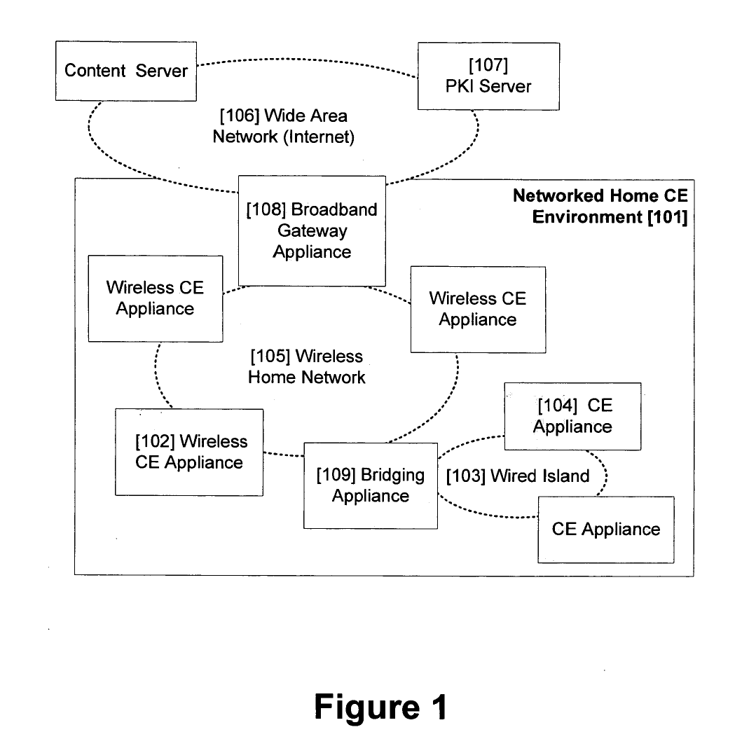

Networked home appliances 102 and 104 are illustrated at FIG. 1. Several embodiments described herein include or utilize such an appliance 102 or 104.

### Securing Content for Home Recording and Playback

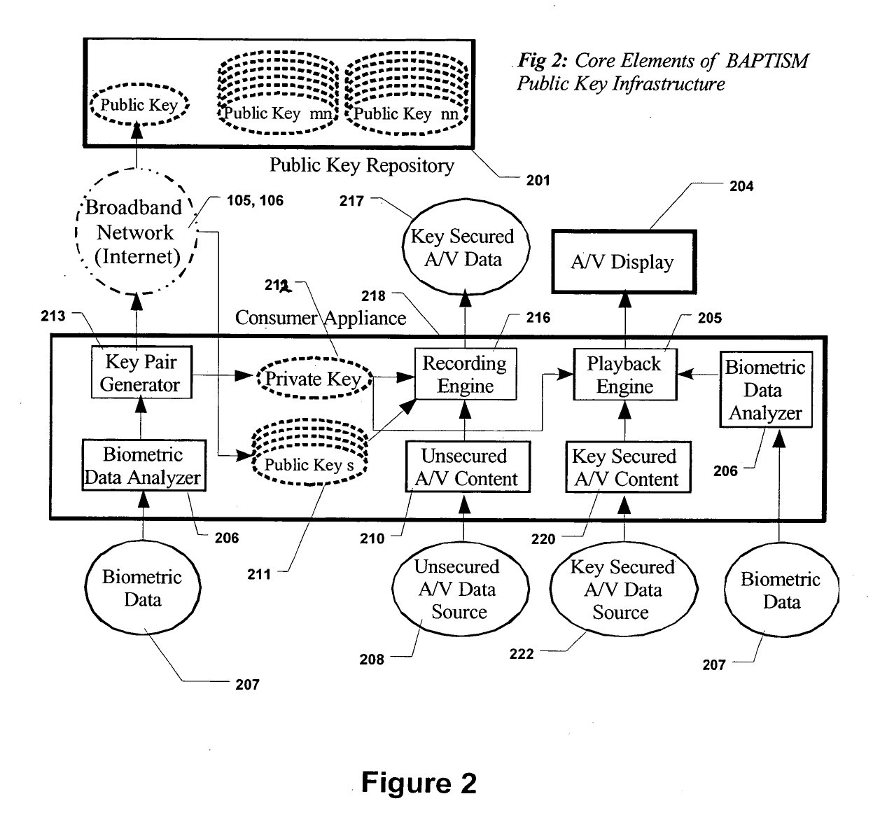

A main architecture in accordance with this embodiment is illustrated in FIG. 2. This embodiment uses biometric identification of a user. This can be readily implemented in an unobtrusive and cost effective manner using recent developments in fingerprint sensing technology. In our preferred embodiment the DKF200 software development kit from Fujitsu Inc is used with the MBF200 fingerprint sensor to implement the biometric data analysis subsystem [206]. The DKF200 kit also includes software libraries from IKendi Software AG (www.ikendi.com) which allow a unique 4-digit number to be generated from a fingerprint. Exemplary methods of generating larger “secrets” from biometric data are described below.

Although the level of differentiation between individual fingerprints provided by the DKF200 is generally adequate for home use, it may be desirable to provide an enhanced degree of differentiation for more global usage. This can be advantageously provided by incorporating a unique serial number embedded in the hardware and/or firmware of the host CE appliance. By combining this serial number, which uniquely identifies the CE appliance, with the biometric signature, a globally unique seed may be determined for generating a unique private/public key pair. The system may alternatively employ face recognition or voice analysis technology, or a combinations thereof, to achieve a repeatable biometric signature linked to an individual consumer and, optionally, a specific CE appliance.

A recent review of techniques for generating cryptographic keys from biometric signatures is provided by Uludag et al in “Biometric Cryptosystems: Issues and Challenges” from Proceedings of the IEEE 92(6) pp 948-960, incorporated herein by reference. Several additional techniques may be employed in further embodiments. Accordingly, U.S. Pat. No. 5,680,460 to Tomko et al, U.S. Pat. No. 6,035,398 to Bjorn, and U.S. Patent Application 2004/0148509 to Wu are hereby incorporated herein by reference.

When the system of FIG. 2 is initialized, a user activates the CE appliance with their biometric signature, generating an immutable public/private key-pair. The user first presents the biometric input [207] which is analyzed to confirm that the data constitutes a unique and repeatable digital signature [206]. A portion of this signature, optionally combined with a serial number from the CE appliance, is then used to generate a unique public/private key pair within a Key-Pair Generator subsystem [213]. The private key may be stored locally [212] and can preferably only be transferred outside the CE appliance 218 in special circumstances which will be described later. Alternatively, the private key may be regenerated dynamically within the CE appliance 218, as required. This is advantageous because if the private key were readily accessible, as it is on a desktop computer, then data signed or secured by the end-user associated with that key could be compromised.

A passphrase for the private key may be generated dynamically from a second portion of the biometric signature and, optionally, from a portion of the serial number of the CE appliance 218, as may be required by the system workflow. This passphrase may be required to actuate use of the private key 212 within the CE appliance 218.

The associated public key 211 is transferred outside the appliance via a means of data output such as a network connection, or alternatively by removable data storage such as a smart card or computer memory card. The preferred embodiment is for this data export to be achieved through a broadband network connection 105, 106 to the Internet. In this case the associated public key is then exported over the broadband network to a public key repository [201] where it is available to those who wish to generate key-secured content [217] for the owner of the key 211.

Verification that the exported public key has been genuinely derived from a biometric signature can be obtained through a variety of means. Recent initiatives, such as the EuropePKI (www.europepki.org) are dealing with such issues using 3rd party certificate providers and electronic notarization techniques.

In a preferred embodiment the biometric sensor subsystem which determines the biometric signature of an individual, also incorporates a subsystem specific private key. This private key may be used to sign or otherwise authenticate exported biometrically derived public keys. Additional techniques described in U.S. patent applications 2002/0186838 to Brandys, 2002/0176583 to Buttiker et al, 2002/0188854 to Heaven et al, 2003/0135740 to Eli et al and 2003/0212893 to Hind et al are incorporated herein by reference, and may be advantageously employed in certain embodiments.

The public key may, optionally, be stored locally [211] with the public keys of family members and friends. These locally stored public keys 211 are those most commonly applied by end-users and they are employed to copy digital content which is generally only accessible to the owners of those keys 211. Keeping a local copy serves to simplify the process of making a secure copy because the end-user of the appliance can scroll through the locally stored public keys 211. If a key is not stored locally then a search for that person's public key can be initiated on the network. This is a more involved process and requires more complex interaction with the end-user. Thus commonly used public keys will be preferably stored locally in the public key equivalent of an e-mail address list.

The private key 212 is retained internally by the CE appliance 218 and is used to sign copies of multimedia content recorded by the CE appliance and to decrypt key-secured multimedia content [217] which has been encoded using the consumers public key. In addition to the generation of key-pairs, two main functions implemented with the system illustrated at FIG. 2 include:
(i) securing or encoding, via a recording (or rebroadcast) engine [216], unsecured digital multimedia content [210] from a variety of A/V (audio/video) sources [208] such as analog TV/video input (conversion to MPEG is implied), MPEG inputs or other digital formats such as AVI or DivX; and
(ii) applying a private key to or decoding, via a playback engine [205], digital multimedia content which was previously secured using the public key of this CE appliance 218, and initiating playback of this key-secured content on a local video display or TV set [204].

Activating either of these functions may involve a user presenting a biometric signature as a passphrase to initiate the encoding or decoding processes. In certain embodiments the biometric signature, or a predetermined portion thereof, may be temporarily stored on an originating CE appliance and, additionally, may be used to dynamically regenerate the private key.

In a preferred embodiment, public key encryption (and/or corresponding decryption) is integrated with a content specific recording or playback subsystem within the CE appliance. In the context of software operating on a desktop PC, this implies that the encryption (or decryption) engine is built directly into the audio/video codec module of a software program. Thus, content is not encoded and then separately encrypted, but rather these processes occur in a single operation. Exemplary embodiments of integrated video and cryptographic encoding are provided in: “Protection of Multicast Scalable Video by Secret Sharing: Simultion Results” from the Proceedings of IS&T/SPIE Electronic Imaging 2003, to Eskicioglu et al; and “Multi-layer Multicast Key Management with Threshold Cryptography”, Proceedings of IS&T/SPIE Electronic Imaging 2004, to Dexter et al, herein incorporated by reference.

Furthermore, as symmetric key encryption is significantly faster for encrypting/decrypting data, the preferred embodiment uses private/public key pairs to encrypt/decrypt a header block in a multimedia stream which contains a conventional symmetric key. This technique is employed by well known PKI client applications such as PGP (http://www.pgp.com) and GnuPG, http://www.gnupg.org/ and otherwise as may be known to those skilled in the cryptographic arts.

In the preferred embodiment a symmetric key is randomly generated, but in certain embodiments, the key may be derived from or otherwise combined with a biometric signature, or a key pair derived from the signature using techniques described elsewhere herein. In the preferred embodiment, the header block may optionally contain a signature derived from an internal private key of the biometric sensor subsystem used to generate biometric signatures within an originating CE appliance. Such a signature can provide auditable information regarding the origin of the encoded content.

Other prior art techniques, in particular those described in U.S. Patent Applications 2003/0126432 to Tonisson, 2002/0114458 to Belenko et al, 20030/217271 to Calder and 2003/0212893 to Hind et al, which are incorporated herein by reference, may be advantageously employed in certain embodiments.

### Content Provider Services

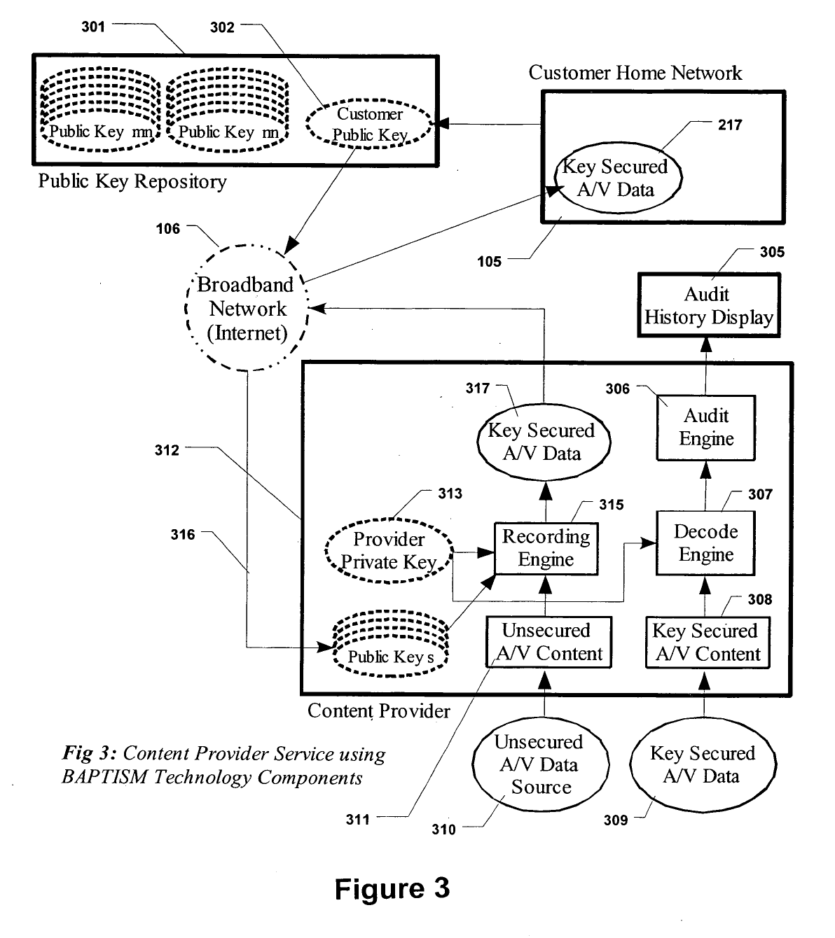

A public key infrastructure in accordance with a preferred embodiment may be employed by content providers. Examples of potential services which could be offered to consumers include key-secured DVDs and network based video-on-demand (VOD) services. An illustrative implementation of such a service is illustrated in FIG. 3.

In this preferred embodiment, a content provider receives a request from a consumer for access to some multimedia content that will also be provided with a public key for the customer [302] or a means to locate such key from a public key repository [301]. Once the customer's key is loaded [316] onto the content providers system [312] they proceed to access the original content [311] from their local data infrastructure [310] and to encode and copy the data, via a recording subsystem [315], onto a DVD [317] which can then be mailed to the consumer. Alternatively, for a VOD service the requested multimedia content is encoded and streamed over the network to the consumer [317]. All content generated by a content provider service must be signed with the company private key [313] which allows for future auditing of DVDs.

A key benefit of this method of content distribution is that every DVD is unique to a single consumer and can only be used by that consumer. This effectively prevents pirates from making bitcopies of a DVD for the simple reason that each DVD is uniquely encoded with the public key of a biometrically verifiable consumer's signature. Another interesting side-effect is that this embodiment provides a unique means for individual artists to directly distribute their works digitally without entering into contracts with large music publishers.

This embodiment also allows content providers to maintain or obtain an audit trail on digital content they have released. Such content will be signed by their private key and, as the originator of the content, this will allow them to test and extract audit information from copies of the original digital content data. This process is also illustrated in FIG. 3. The key secured audio/video data [309] may be obtained and processed for audit. This data is loaded into the content provider's system [308] and is then processed by an enhanced decode engine [307] which can extract data regarding the public keys with which the digital content has been encoded and the private key with which the content copy was signed. Note that only the originator of the master copy of the content can perform such an audit. This information is passed into an audit engine [306] which determines the form of content licensing which was purchased by the customer for this content and determines if a licensing violation has occurred. The audit engine will access various customer databases and IT subsystems of the content providers system during this processing step. Finally an audit history report [305] for this particular digital content can be generated and displayed to an operator, or alternatively, stored for future reference.

### Data Rebroadcast over a Wireless Home Network

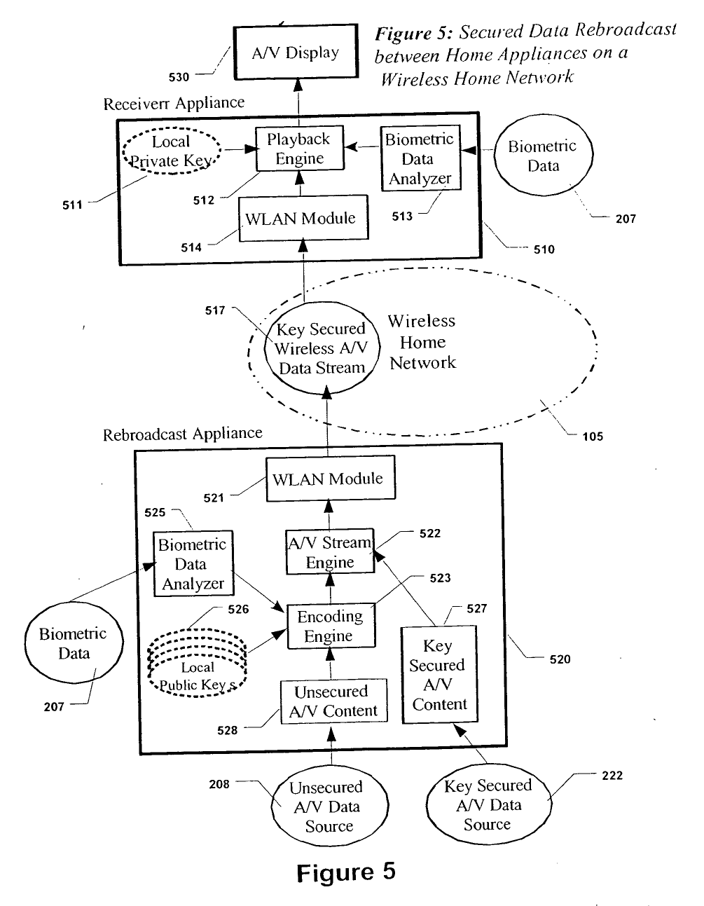

Copyright infringement can occur when a user rebroadcasts audio or video content over a wireless home network. In principle this could be construed as an instance of ‘fair use’, but as other persons in an adjacent dwelling could also access the rebroadcasted music or video there is a genuine cause for concern on the part of the copyright holder. In accordance with a preferred embodiment, a rebroadcast data stream is encoded at the source, prior to rebroadcast, with the public key of the owner of the data. If the data is already in the form of a key-secured data stream, then this encoding step is preferably not used. At the receiving appliance, the biometric signature of the owner of the data is required in order to unlock the data stream using the relevant private key. Typically the rebroadcasting and receiving appliances would share the same private key which would be securely transferred between appliances using one of the methods described below. A detailed schematic in accordance with a rebroadcast embodiment is illustrated at FIG. 5, which incorporates many of the same components that were described in earlier embodiments above and that will not be described in detail here.

### Private Key Sharing

In the architecture of the preferred embodiment, the system's private key is embedded in the firmware of a broad range of consumer appliances. Assuming that reasonable security precautions are taken with these appliances, it will be difficult to tamper with the system's private keys. However, a determine hacker could determine the means used to create keys and publicly provide access to a “cracked” key pair. Such key pairs should be removed from the official public key servers used by the system. An opt-in approach is also desired, wherein a user chooses to adopt features of the preferred embodiment because they wish to demonstrate that they are not abusing their rights to copy digital content.

In the context of private keys, it is desirable that an end user of the system of the preferred embodiment have a single private key associated with their biometric signature. This is more a convenience to the end-user who would like to be able to play the same movie or music on multiple consumer appliances. Thus it is desirable that each appliance does not create its own unique private key, but can access, instead, a single master private key. This capability is provided in the system of the preferred embodiment without compromising the security of the master private key.

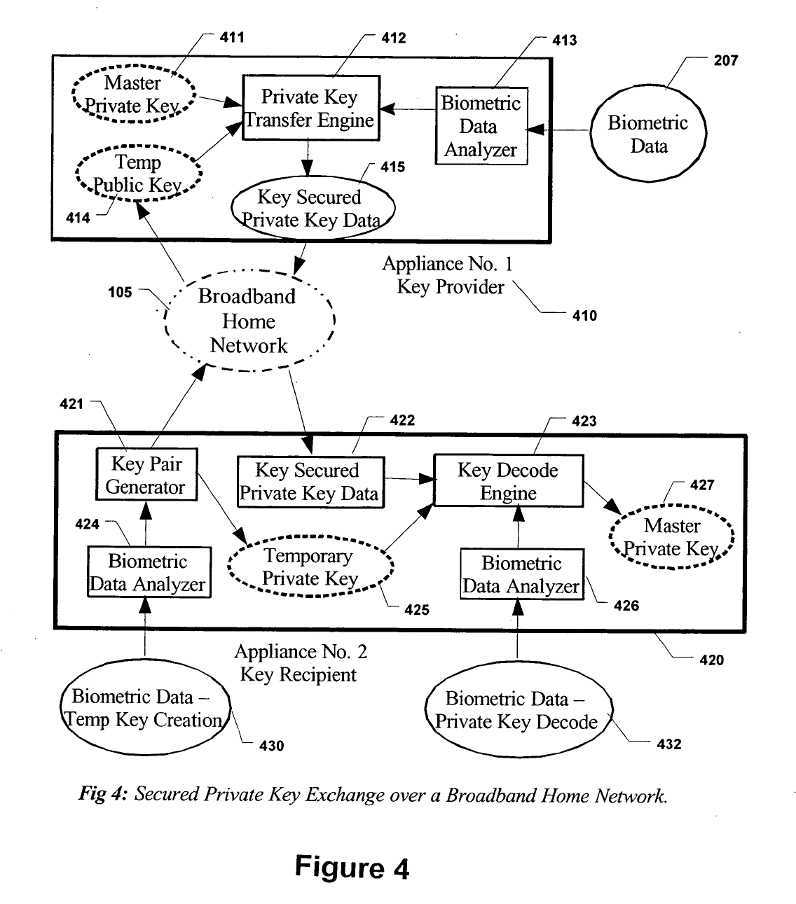

FIG. 4 illustrates how secured exchange of a private key may occur over a local home network. To initiate the exchange, the user biometrically activates a private key transfer engine in the appliance which holds the master private key. If the private key selected for transfer matches the activation signature then the appliance makes a local network broadcast that it is prepared for key transfer. To complete the key exchange, the user activates in receive mode the private key transfer engine of the receiving appliance. This generates a temporary local key-pair, locates the transferring appliance on the local network, and exports the temporary public key to the transferring appliance. The transferring appliance next encrypts the master private key with the temporary public key that it has received from the receiving appliance and then transfers the encrypted master private key to this receiving appliance. Preferably, network transfers of temporary public keys and encrypted private keys are made over SSH, further proofing the system against eavesdropping.

In this embodiment or in an alternative embodiment, the end user may activate transfer mode on the first appliance using their fingerprint as an activation code. The end user then verifies themselves by fingerprinting a second appliance and the key transfer sequence is completed. In this way, a single private key for a particular person can be shared by multiple CE appliances in the home network (or by mobile devices which are brought into the home environment) and a single public key for all appliances can be used by the person.

Using similar methods, the “master” user for a home network can also create additional key-pairs for other family members. In such a case the master device (the CE appliance that created the original key-pair for the master user) is biometrically activated by the master user and placed into a key-pair generation mode. A second biometric signature should now be generated within a certain timeout period and the master device will next create a new unique key-pair for the new user and will allow its user access to the capabilities of the device.

In certain embodiments, a hierarchical order of privilege to new keys may be imposed. Thus, the master key would have access to all the functionality of a device, somewhat like a root user or administrator on a desktop computer system, while secondary users would have more restricted rights, somewhat like power users, and given that secondary users can also create tertiary users, these will only have highly restricted access to the functionality of a device.

Within a typical home network, a normal workflow would be for a first device to be purchased and biometrically initialized by the “master”-user. Key-pairs for additional family members would then be added to this device. When a second device is purchased the private key transfer process described above is initiated. This transfer process can allow keys to be transferred individually, but in its normal mode of operation it will transfer all keys, thus further simplifying the workflow for the end-user.

In certain embodiments, the private key may be dynamically recreated and relies on additional data derived from the hardware of the original CE appliance on which the key was created. In such embodiments, the hardware data may be made available to other CE appliances in the same manner as private key transfer is effected. Note that it is not desirable to store a unique hardware code permanently on other CE appliances as this could facilitate system abuse. Thus, in a preferred embodiment, it is not the hardware data itself which is made available, but rather a secure link is provided to allow remote recreation of the private key from hardware data on the original CE appliance combined with biometric signature data which is verified on a second networked appliance.

A concern with such a system is that the original hardware data may be lost if the CE appliance becomes dysfunctional or is obsoleted and removed from the local home network. The problem of obsolescence may be solved by either facilitating a permanent transfer of the secure hardware token to a second CE appliance, after deletion on the original appliance. The problem of a dysfunctional appliance may be solved through use of a network-based escrow service to securely store newly generated private keys.

All of the references cited herein above, in addition to that which is described as background including FIG. 1, are hereby incorporated by reference into the detailed description of the preferred embodiments, as disclosing alternative embodiments of elements or features of the preferred embodiments that may not otherwise be set forth in detail herein. In addition to references cited above, the following are incorporated by reference:
(i) Security enhanced MPEG player; Yongcheng Li Zhigang Chen See-Mong Tan Campbell, R. H.; Dept. of Comput. Sci., Illinois Univ., Urbana, Ill., USA; Proceedings of the IEEE International Workshop on Multimedia Software Development, 1996.
(ii) A fast video encryption scheme suitable for network applications; Shiguo Lian Zhiquan Wang Jinsheng Sun; Dept. of Autom., Nanjing Univ. of Sci. & Technol., China 2004 International Conference on Communications, Circuits and Systems, 2004 (ICCCAS 2004).
(iii) X. Xu, S. Dexter, & A. M. Eskicioglu; A Hybrid Scheme for Encryption and Watermarking, Proceedings of IS&T/SPIE Electronic Imaging 2004, San Jose, Calif., January 2004.
(iv) An integrated approach to encrypting scalable video Eskicioglu, A. M.; Delp, E. J.; Proceedings of the 2002 IEEE International Conference on Multimedia and Expo, 2002. (ICME '02)., Volume: 1, 26-29 August 2002, Pages: 573-576 (v) Lightweight and cost-effective MPEG video encryption Choon, L. S.; Samsudin, A.; Budiarto, R.; Proceedings of 2004 International Conference on Information and Communication Technologies; 19-23 April 2004 Pages: 525-526

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention, as set forth in the claims below, and functional and structural equivalents thereof.

In addition, in methods that may be performed according to preferred embodiments herein and that may have been described above or recited in the claims below, the operations, step, and/or processes have been described in selected typographical sequences. However, the sequences have been selected and so ordered for typographical convenience and are not intended to imply any particular order for performing the operations.

1. A secure digital content reproduction method, comprising:
(a) identifying an individual user at a first CE appliance with at least one repeatable biometric signature linked to the individual user;
(b) from the biometric signature, generating a private-public cryptographic key pair;
(c) providing the public key to one or more sources of digital content;
(d) receiving at the first CE appliance digital content secured with the public key;
(e) applying the private key, thereby permitting rendering of the secured digital content.

2. The method of claim 1, further comprising generating a passphrase from the biometric signature linked to the individual user for actuating the private key.

3. The method of claim 1, wherein the identifying actuates the private key for a limited time.

4. The method of claim 1, further comprising rendering said digital content on a content-specific playback subsystem.

5. The method of claim 1, wherein said digital content that is received at said first CE appliance comprises broadcast content.

6. The method of claim 1, further comprising broadcasting said digital content over a local network.

7. The method of claim 1, further comprising regenerating a key pair on successive uses of digital content.

8. The method of claim 1, further comprising identifying the first CE appliance with a serial number unique to the first CE appliance.

9. The method of claim 1, further comprising securely providing the private key to a second CE appliance, so that the digital content is decryptable there upon receipt.

10. The method of claim 9, wherein the first and second CE appliances are configured within a network.

11. The method of claim 10, wherein the second CE appliance receives the digital content as a broadcast from the first CE appliance.

12. The method of claim 9, wherein the first CE appliance approximately simultaneously receives the content broadcast from an outside source along with the second CE appliance.

13. The method of claim 9, wherein the providing of the private key comprises repeating the identifying and generating at the second CE appliance.

14. The method of claim 9, wherein the providing of the private key comprises electronically sending the private key via a secure link.

15. The method of claim 14, wherein sending the private key by secure link comprises receiving a temporary key pair generated at a second CE appliance, encrypting the private key with the temporary public key, sending the private key to the second CE appliance which is decryptable there with the temporary private key.

16. The method of claim 15, wherein said private key is actuated by input of a passphrase generated from a repeatable biometric signature.

17. The method of claim 1, wherein the digital content is digitally signed with the private key of the content provider.

18. The method of claim 17, further comprising receiving an audit at the first CE appliance wherein resident content is checked for the digital signing.

19. The method of claim 17, wherein the digital content further comprises audit history data which is additionally encoded with the public key of the content provider.
(a) from the repeatable biometric signature of an individual user, generating a private-public cryptographic key pair;
(b) providing the public key to one or more sources of digital content;
(c) receiving at a first CE appliance digital content secured with the public key;
(d) applying the private key, thereby permitting rendering of the secured digital content; and
(e) securely providing the private key to a second CE appliance so that the digital content is decryptable there upon receipt.

21. The method of claim 20, wherein securely providing the private key comprises biometrically regenerating the private key at the second CE appliance.

22. The method of claim 20, wherein securely providing the private key comprises receiving a temporary key pair generated at a second CE appliance, encrypting the private key with the temporary public key, sending the private key to the second CE appliance which is decryptable there with the temporary private key.

23. The method of claim 22, further comprising actively verifying the user's signature upon generated of the temporary key-pair creation or upon receipt of the private key, or both.

24. The method of claim 20, further comprising configuring the first and second CE appliances within a network.

25. The method of claim 24, further comprising broadcasting the digital content from the first CE appliance.

26. The method of claim 20, wherein the first CE appliance approximately simultaneously receives the content broadcast from an outside source along with the second CE appliance.

27. The method of claim 20, further comprising biometrically regenerating a key pair on successive uses of digital content.

28. The method of claim 20, further comprising identifying one or more of the CE appliances with a serial number unique to each CE appliance.

29. The method of claim 20, wherein providing the private key comprises repeating the key pair generating for each of the one or more other CE appliances.

30. The method of claim 20, further comprising generating a passphrase from the biometric signature linked to the individual user for actuating the private key.

31. The method of claim 20, further comprising rendering said digital content on a content-specific playback subsystem.

32. A digital content copyright policing method, comprising:
(a) receiving a public key from a CE appliance;
(b) digitally signing digital content with the private key of the content provider;
(c) sending the digital content to the CE appliance secured with the public key of the CE appliance and signed with the private key of the content provider, and
(d) wherein the content is decryptable at the CE appliance with the private key complement of said public key, and is auditable by checking the content for the digital signing.

33. The method of claim 32, wherein the public key received has been generated based upon a repeatable biometric signature linked to an individual user.

34. The method of claim 33, further comprising auditing the CE appliance by checking the content for the digital signing.

35. The method of claim 33, where the digital content further comprises audit history data that is additionally encoded with the public key of the content provider.

36. The method of claim 35, further comprising auditing the digital content by checking for audit history data or digital signing, or both.

37. One or more processor readable storage devices having processor readable code embodied thereon, said processor readable code for programming one or more processors to perform a method of secure reproduction of digital content, the method comprising:
(a) identifying an individual user at a first CE appliance with at least one repeatable biometric signature linked to the individual user;
(b) from the biometric signature, generating a private-public cryptographic key pair;
(c) providing the public key to one or more sources of digital content;
(d) receiving at the first CE appliance digital content secured with the public key;
(e) applying the private key, thereby permitting rendering of the secured digital content.

38. The one or more storage devices of claim 37, the method further comprising generating a passphrase from the biometric signature linked to the individual user for actuating the private key.

39. The one or more storage devices of claim 37, wherein the identifying actuates the private key for a limited time.

40. The one or more storage devices of claim 37, the method further comprising rendering said digital content on a content-specific playback subsystem.

41. The one or more storage devices of claim 37, wherein said digital content that is received at said first CE appliance comprises broadcast content.

42. The one or more storage devices of claim 37, the method further comprising broadcasting said digital content over a local network.

43. The one or more storage devices of claim 37, the method further comprising regenerating a key pair on successive uses of digital content.

44. The one or more storage devices of claim 37, the method further comprising identifying the first CE appliance with a serial number unique to the first CE appliance.

45. The one or more storage devices of claim 37, the method further comprising securely providing the private key to a second CE appliance, so that the digital content is decryptable there upon receipt.

46. The one or more storage devices of claim 45, wherein the first and second CE appliances are configured within a network.

47. The one or more storage devices of claim 46, wherein the second CE appliance receives the digital content as a broadcast from the first CE appliance.

48. The one or more storage devices of claim 45, wherein the first CE appliance approximately simultaneously receives the content broadcast from an outside source along with the second CE appliance.

49. The one or more storage devices of claim 45, wherein the providing of the private key comprises repeating the identifying and generating at the second CE appliance.

50. The one or more storage devices of claim 45, wherein the providing of the private key comprises electronically sending the private key via a secure link.

51. The one or more storage devices of claim 50, wherein sending the private key by secure link comprises receiving a temporary key pair generated at a second CE appliance, encrypting the private key with the temporary public key, sending the private key to the second CE appliance which is decryptable there with the temporary private key.

52. The one or more storage devices of claim 51, wherein said private key is actuated by input of a passphrase generated from a repeatable biometric signature.

53. The one or more storage devices of claim 37, wherein the digital content is digitally signed with the private key of the content provider.

54. The one or more storage devices of claim 53, the method further comprising receiving an audit at the first CE appliance wherein resident content is checked for the digital signing.

55. The one or more storage devices of claim 53, wherein the digital content further comprises audit history data which is additionally encoded with the public key of the content provider.

56. One or more processor readable storage devices having processor readable code embodied thereon, said processor readable code for programming one or more processors to perform a method of secure reproduction of digital content, the method comprising:
(a) from the repeatable biometric signature of an individual user, generating a private-public cryptographic key pair;
(b) providing the public key to one or more sources of digital content;
(c) receiving at a first CE appliance digital content secured with the public key;
(d) applying the private key, thereby permitting rendering of the secured digital content; and
(e) securely providing the private key to a second CE appliance so that the digital content is decryptable there upon receipt.

57. The one or more storage devices of claim 56, wherein securely providing the private key comprises biometrically regenerating the private key at the second CE appliance.

58. The one or more storage devices of claim 56, wherein securely providing the private key comprises receiving a temporary key pair generated at a second CE appliance, encrypting the private key with the temporary public key, sending the private key to the second CE appliance which is decryptable there with the temporary private key.

59. The one or more storage devices of claim 58, the method further comprising actively verifying the user's signature upon generated of the temporary key-pair creation or upon receipt of the private key, or both.

60. The one or more storage devices of claim 56, the method further comprising configuring the first and second CE appliances within a network.

61. The one or more storage devices of claim 60, the method further comprising broadcasting the digital content from the first CE appliance.

62. The one or more storage devices of claim 56, wherein the first CE appliance approximately simultaneously receives the content broadcast from an outside source along with the second CE appliance.

63. The one or more storage devices of claim 56, the method further comprising biometrically regenerating a key pair on successive uses of digital content.

64. The one or more storage devices of claim 56, the method further comprising identifying one or more of the CE appliances with a serial number unique to each CE appliance.

65. The one or more storage devices of claim 56, wherein providing the private key comprises repeating the key pair generating for each of the one or more other CE appliances.

66. The one or more storage devices of claim 56, the method further comprising generating a passphrase from the biometric signature linked to the individual user for actuating the private key.

67. The one or more storage devices of claim 56, the method further comprising rendering said digital content on a content-specific playback subsystem.

68. One or more processor readable storage devices having processor readable code embodied thereon, said processor readable code for programming one or more processors to perform a method of secure reproduction of digital content, the method comprising:
(a) receiving a public key from a CE appliance;
(b) digitally signing digital content with the private key of the content provider;
(c) sending the digital content to the CE appliance secured with the public key of the CE appliance and signed with the private key of the content provider, and
(d) wherein the content is decryptable at the CE appliance with the private key complement of said public key, and is auditable by checking the content for the digital signing.

69. The one or more storage devices of claim 68, wherein the public key received has been generated based upon a repeatable biometric signature linked to an individual user.

70. The one or more storage devices of claim 69, the method further comprising auditing the CE appliance by checking the content for the digital signing.

71. The one or more storage devices of claim 69, wherein the digital content further comprises audit history data that is additionally encoded with the public key of the content provider.

72. The one or more storage devices of claim 71, the method further comprising auditing the digital content by checking for audit history data or digital signing, or both.
